(19) United States
(12) Patent Application Publication
(10) Pub. No.: US 2010/0273124 A1
(43) Pub. Date: Oct. 28, 2010

(54) STEADY PRESSURE DENTAL IMPRESSION TRAY AND THE IDEA OF OPERATION

(76) Inventor: Monika Borczyk, Bielsko-Biala (PL)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/747,464

(22) PCT Filed: Nov. 17, 2008
(86) PCT No.: PCT/PL2008/000084

§ 371 Date: Jun. 10, 2010

(30) Foreign Application Priority Data
Dec. 17, 2007 (PL) P-384078

(51) Int. Cl. A61C 9/00

(52) U.S. Cl. 433/37

(57) ABSTRACT

An object making its impression in soft material, due to the force application, of various strength and impact directions, reproduces its parts at different heights, thus providing a distorted cast of the object.

### BACKGROUND OF THE INVENTION

Dental impression trays are used to create negative reproductions of a patient's teeth. To take an impression, the dental impression tray is usually filled with a flowable impression material, and then the tray is placed in the patient's mouth and pressed against the teeth. Once the impression material has become solid, the tray is peeled away from the teeth and removed from the patent's mouth.

The well known, standard dental impression tray comprises the part used for reproduction of the prosthetic area in a patient's mouth and the grip member protruding outside the range of this part. There is also known a dental impression tray comprising the part used for reproduction of the prosthetic area in a patient's mouth and the handle member, fixed to the gingival area of the impression tray alongside the length its arch. The handle member may have whatever holes and additionally a hook handle, but it does not protrude outside the part used for reproduction of the prosthetic area in a patient's mouth.

### BRIEF SUMMARY OF THE INVENTION

The invention consists of the part used for reproduction of the prosthetic area in a patient's mouth, the grip member protruding outside this, and the mould and/or the structure, such as hydraulic or pressure structure.

The steady pressure impression tray provides better or steady application of the pressure force during the impression taking.

### BRIEF DESCRIPTION OF THE SEVERAL VIEWS OF THE DRAWING

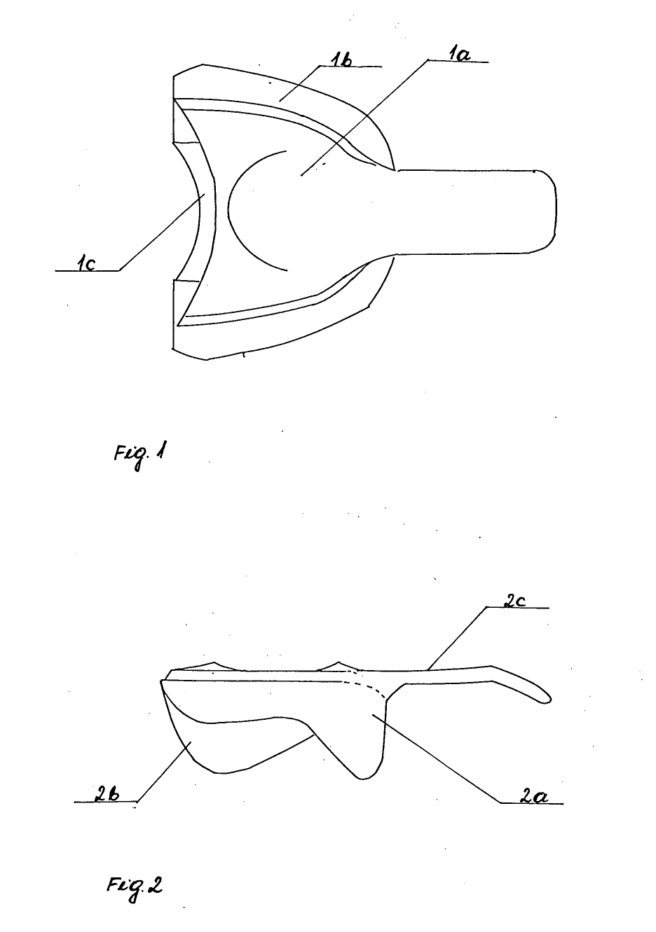

The subject of the invention has been illustrated by the examples of dental impression tray models, in the drawings , where: FIG. 1 a position 1a—this is a mould, FIG. 1 a position 1b—this is the gingival area/its range includes the alveolus gum/, FIG. 1 a position 1c—the palatal part/its range includes the palate/, FIG. 2 a position 2a—the outer part of a dental impression tray/it is located opposite the inner part, where the impression material is/FIG. 2 a position 2b—the inner part of a dental impression tray/it is the place where the impression material is placed/, FIG. 2 a position 2c—the grip member of a dental impression tray, FIG. 3 a position 3a—the inter-gingival line of the mould, FIG. 3 a position 3b—the gingival line of the mould, FIG. 3 a position 3c—the mould surface, FIG. 101 a position 101a—the lingual area is located in the gingival area of a dental impression tray, at the tongue side in a lower or partial dental impression tray, FIG. 104 a position 104a—the mould as the grip member, FIG. 164 a position 164a—the palatal/lingual line, FIG. 173 a position 173a—the part used for reproduction of the prosthetic area in a patient's mouth/its range includes the patient's gums, teeth and palate/, FIG. 174 a position 174a—the pressure structure

1. Example of the upper dental impression tray—the top view.

1a. A mould.

1b. The gingival area.

1c. The palatal area.

2. Example of upper impression tray—the side view.

2a. Outer part of the tray.

2b. Inner part of the tray.

2c. A standard, well known grip member of a dental impression tray.

3. Example of upper impression tray—the top view

3a. The inter-gingival line of the mould.

3b. The gingival line of the mould.

3c. The mould surface.

4. Example of the run of the inter-gingival line and fragment of a dental impression tray from 5. to 18. Examples of the inter-gingival line/lines—the top view. The inter-gingival line/lines are located between the gums and/or across the gingival area of a dental impression tray and end at any point between the front and back side of a dental impression tray.

19. Example of a dental impression tray—the top view.

3a. The inter-gingival line is located more or less in the middle of the gingival area of the impression tray—it may have any shape and end at any points of the gingival area of the impression tray, similar to the examples from 5. to 18.

20. Example of a dental impression tray—the top view.

3a. The inter-gingival line is located beyond the middle point of the part used for reproduction of the prosthetic area in the patient's mouth, it may have any shape and end at any points of the gingival area of the impression tray, similar to the examples from 5. to 18.

21. Example of a dental impression tray the cross-section view.

3a. The inter-gingival line—the cross-section view. from 22 to 79. Examples of the inter-gingival lines—the cross-section view. The line/lines is/are a combination of various inclination angle, radiant, length. the ends in their gingival area and/or palatal area may be located at any point of the gingival and/or palatal area of a dental impression tray.

80. Example shape of a dental impression tray the cross-section view.

3a. The inter-gingival line is connected to the upper side of the gingival area of a dental impression tray, close to the outer side of the gingival area of a dental impression tray.

80a. The outer side of the gingival area of a dental impression tray/this is the gingival area from the cheek and lip side/

81. Example shape of a dental impression tray the cross-section view.

3a. The inter-gingival line reaches beyond the upper side of the gingival area of a dental impression tray. The cross-section view is connected to the gingival area of a dental impression tray, throughout the upper side of the gingival area of a dental impression tray.

81a The upper side of the gingival area of a dental impression tray/the gingival area including the upper side of the tooth alveolus gum.

82. Example of impression tray shape—the cross section view.

The ends of the inter-gingival lines are connected to the gingival area of a dental impression tray—the cross-section view—at the ends of the upper side of the gingival area of a dental impression tray.

83. Example of impression tray shape—the cross-section view.

The ends of the inter-gingival lines are connected to the gingival area of a dental impression tray—the cross-section view—beyond the middle of the upper side of the gingival area of a dental impression tray and near the inner side of the gingival area of a dental impression tray.

83a. The inner side of the gingival area of a dental impression tray/constitutes the lingual area in the lower dental impression tray or a fragment of the palatal area in the upper dental impression tray.

84. Example shape of a dental impression tray—the cross-section view.

3a. The inter-gingival line is connected to the upper side of the gingival area of a dental impression tray, near the inner side of the gingival area of a dental impression tray.

85. Example cross section of a dental impression tray. The mould is connected to nearly one half of the upper side of the gingival area of a dental impression tray.

86. Dental impression tray shape—the cross-section view.

3a. The inter-gingival line is connected to the upper side of the gingival area of a dental impression tray, approximately in the middle of its width.

87. Example shape of a dental impression tray—the cross-section view.

3a. The inter-gingival line protrudes outside the upper side of the gingival area of a dental impression tray and is connected to the upper side of the gingival area of a dental impression tray, near the outer side of the gingival area of a dental impression tray.

88. Example of impression tray shape—the cross-section view. The inter-gingival lines are connected to the upper side of the gingival area of a dental impression tray, close to its middle point and near the outer side of the gingival area of a dental impression tray.

89. Example of impression tray shape—the cross-section view. The mould is connected to the palatal area.

3a. The inter-gingival line is not connected to the gingival area of the impression tray.

90. Example of impression tray shape—the cross-section view.

The mould is connected to the upper side of the gingival area of a dental impression tray and to its palatal area.

91. Example of dental impression tray shape—the cross-section view. The mould is connected to the gingival and palatal area of a dental impression tray.

92. Example of the lower impression tray shape—the cross-section view. The mould is connected to the upper and lingual side of the gingival area of the lower dental impression tray.

93. Example cross section of the lower impression tray. The mould is connected to the upper and the lingual side of the gingival area of the lower dental impression tray.

94. Example cross section of the lower impression tray. The mould is connected to the lingual side of the gingival area of the lower impression tray.

95. Cross section of the upper impression tray. The mould is connected to the palatal side of a dental impression tray.

96. Example cross section of the upper impression tray.

97. Example cross section of the upper impression tray. The mould is connected to the palatal area of a dental impression tray.

98. Example cross section of the upper impression tray. The mould is connected to the gingival and palatal area of a dental impression tray.

99. Example cross section of the upper impression tray. The mould constitutes the gingival area of a dental impression tray or is connected only to the gingival area of a dental impression tray—the cross-section view.

100. Example cross section of the upper impression tray. The mould constitutes the gingival area of a dental impression tray or is connected only to the gingival area of a dental impression tray—the cross-section view. from 101 to 103. Example cross-section view of a partial impression tray or fragment of the cross-section view of the lower impression tray. The mould constitutes the gingival area of a dental impression tray or is connected only to the gingival area of a dental impression tray the cross-section view. 101 a The lingual area of the lower or partial dental impression tray.

104. Example cross section of the upper impression tray. The mould constitutes the grip member.

104a. Examples of a mould constituting the grip member.

105. Example cross section of the upper impression tray. Inter-gingival line/lines of the mould constituting the grip member may be of any shape and are connected at any point of the gingival and/or palatal area of a dental impression tray.

106. Example cross section of the upper impression tray.

The items indicated, from 1 to 11 and from 1 to 11′, are examples of the mould connection points to a dental impression tray—the cross-section view.

107. Example the upper impression tray—the top view. The mould is connected to the gingival and/or palatal area of a dental impression tray.

108. Example the upper impression tray—the top view. The mould is connected to the gingival and/or palatal area of a dental impression tray. Example of the upper impression tray—the top view—may be the top view of a dental impression tray where the mould is a grip member.

109, 111, 112, 115, 116. Examples of the upper impression tray. The mould is connected to the gingival and/or palatal area of a dental impression tray.

110, 113, 114. Example of a dental impression tray. The mould is connected to the palatal area of a dental impression tray.

117. Example the upper impression tray—the top view. The gingival line of the mould may be located at any point of the gingival and/or palatal area of a dental impression tray. The gingival line runs along the gingival area and/or the palatal area of a dental impression tray.

from 118 to 129. Example fragments of gingival lines.

from 130 to 146. Example fragments of gingival lines.

from 147 to 152. Examples of dental impression trays—the top view. Moulds with perforation, notches, embossing, of various shapes and layouts.

from 153. to 155. Example the upper impression tray—the top view. Moulds with a variety of surfaces.

from 156. to 163. Examples of perforation, notches, embossing, patterns on the mould.

from 164. to 172. Examples of moulds or their fragments, connected to the palatal or gingival area of the impression tray.

164a. The palatal/lingual line.

173. The part used for reproduction of the prosthetic area in a patient's mouth.

174. Example of dental impression tray with the pressure structure. Concentric rings protrude together with the pressure. The concentric rings are ejected under pressure.

174a The pressure structure.

175. Example of a disposable dental impression tray with the pressure structure. Under pressure, part of the structure ejects and stiffens under pressure.

The steady pressure dental impression tray consists of the part used for reproduction of the prosthetic area in a patient's mouth, the grip member protruding outside this part, and the mould or structure, e.g. hydraulic or pressure mechanism. The steady pressure dental impression tray permits for application of the pressure force to the part used for reproduction of the prosthetic area in a patient's mouth.

The impression force is applied through/by means of a mould and/or a structure to the part used for reproduction of the prosthetic area in a patient's mouth.

The grip member protruding out of the part used for reproduction of the prosthetic area has an auxiliary function in the course of inserting and removing the dental impression tray into and out of a patient's mouth.

Lack of such grip member hinders or make it impossible to remove a dental impression tray out of a patient's mouth due to the existence of suction force and the height of a dental impression tray including the impression material.

There is also a possibility of using a steady pressure dental impression tray consisting only of the part used for reproduction of the patient's mouth, the mould and/or the structure, provided that the mould has a grip function or the structure enables removing a dental impression tray out of a patient's mouth. A mould equipped with a hook handle increases the height of a dental impression tray, hindering or limiting the possibility of inserting it into a patient's mouth.

The structure, such as a hydraulic or pressure structure, is preferably connected or connectable to the part used for reproduction of the prosthetic area in a patient's mouth.

The structure, e.g. the pressure structure, elongates its dimension or dimension of its part, resulting in impressing of the prosthetic area in the impression material.

The mould preferably is connected or connectable to the part used for reproduction of the prosthetic area in a patient's mouth, mostly not protruding outside the outline of this part. Some of the examples, where the mould protrudes outside the outline of this part (FIG. 80-88).

The mould or the structure may have a modified shape of a standard dental impression tray, with just slight change to its appearance (99-103).

The mould and/or the part used for reproduction of the prosthetic area in a patient's mouth and/or the structure and/or the grip member may be disconnected and be connectable during the impression taking.

The mould and/or the part used for reproduction of the prosthetic area in a patient's mouth and or the structure and/or the grip member may consist of two or more parts (107-116), disconnected, connected or connectable.

Elements of a dental impression tray—the cross-section view—may be of any thickness, often depending on the material of which it is made.

The mould and/or the structure may be used for full arch, partial or disposable impression trays . . .

The most preferable pressure point is the central part of the part used for reproduction of the prosthetic area in a patient's mouth. The preferable point is/are the gingival area/areas in the middle (FIG. 99-103).

The mould or its part, connected to the palatal and/or gingival and/or lingual area, may have any shape in the cross section and the top view, and the side view (FIG. 109-113, 164-172 . . . ), and its diversity is described by, e.g.: the mould inter-gingival line (FIG. 3, 3a position) the mould gingival line (FIG. 3, 3b position), the mould surface (FIG. 3, 3c position), the palatal/lingual line of the mould (FIG. 164, 164a position).

The inter-gingival line/lines (FIG. 3, 3a position) run across the gingival area of a dental impression tray, between the right and the left side/the left and the right side of a dental impression tray. It/they run from the left to the right/from the right to the left side of a dental impression tray and may run at an angle to the gingival area of a dental impression tray—the cross-section view and/or the longitudinal cross-section and/or the top view, of a dental impression tray. They may be unconnected. It/they may be connected to the palatal area and/or the gingival area and/or the lingual area, at any point of the dental impression tray (FIG. 3, 19, 20, 107-111), running from the left to the right/from the right to the left side of a dental impression tray. It/they may be shorter or longer than the width of a dental impression tray (FIG. 3, 19, 20, 108).

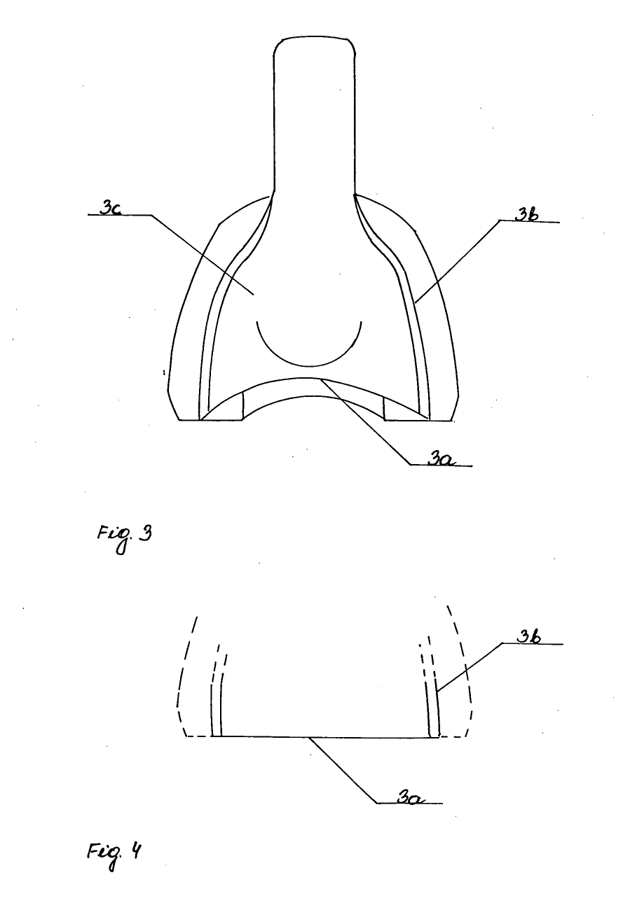

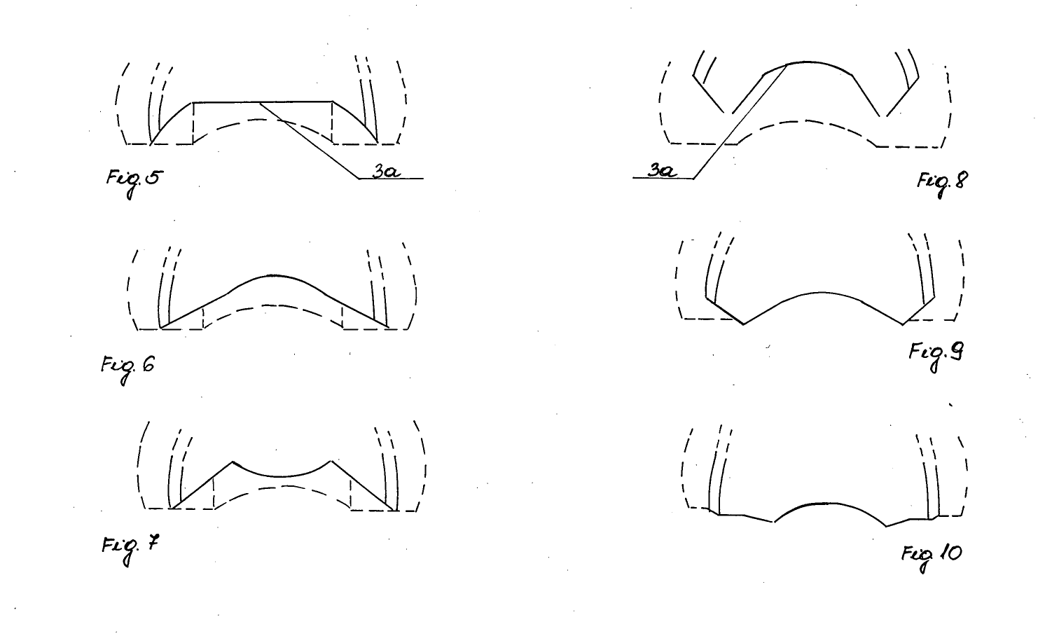

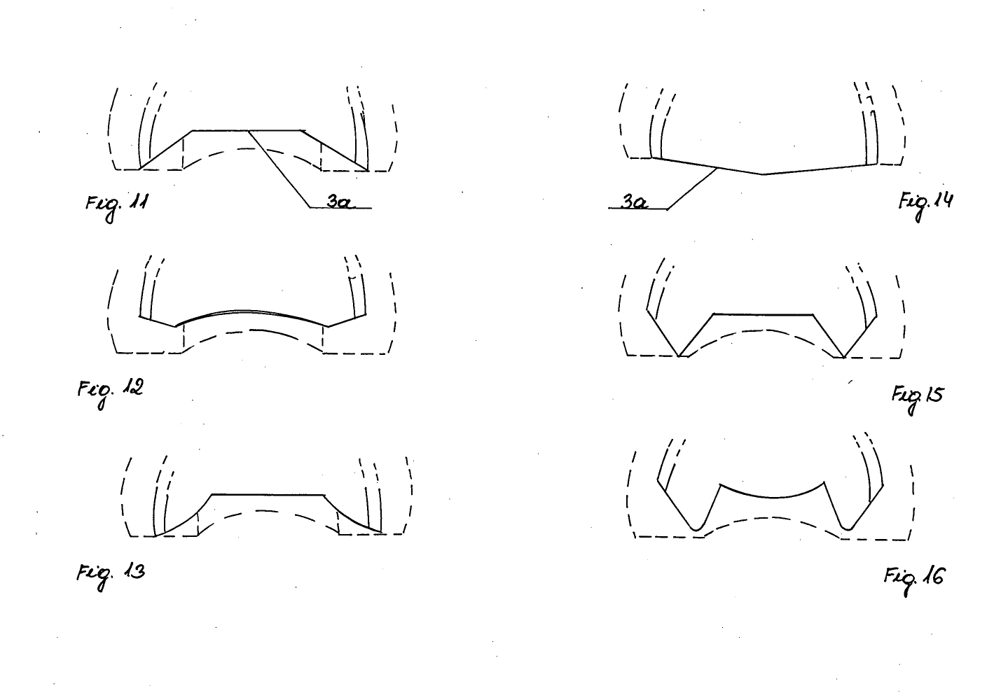

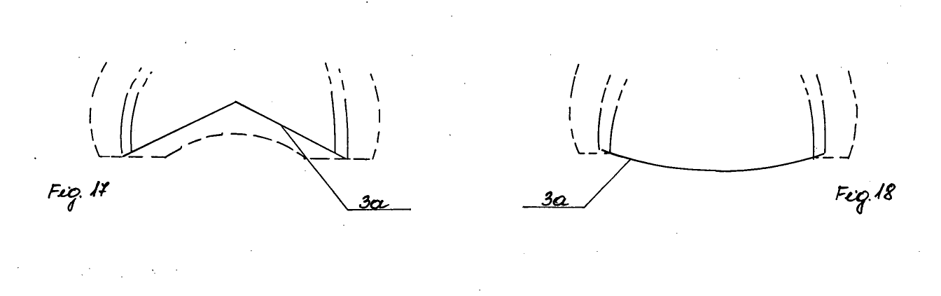

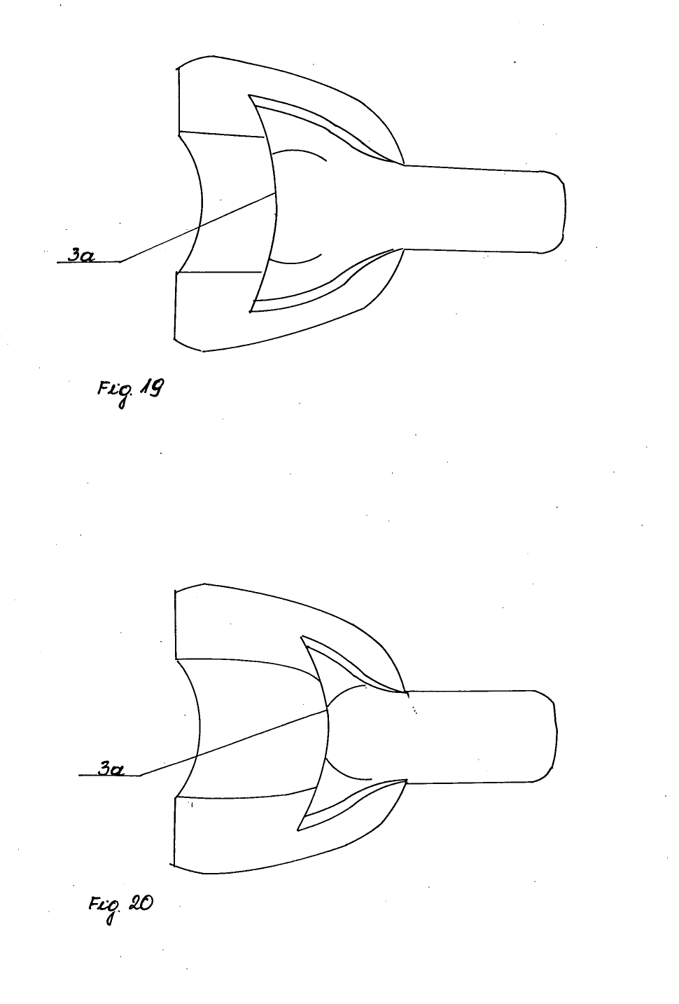

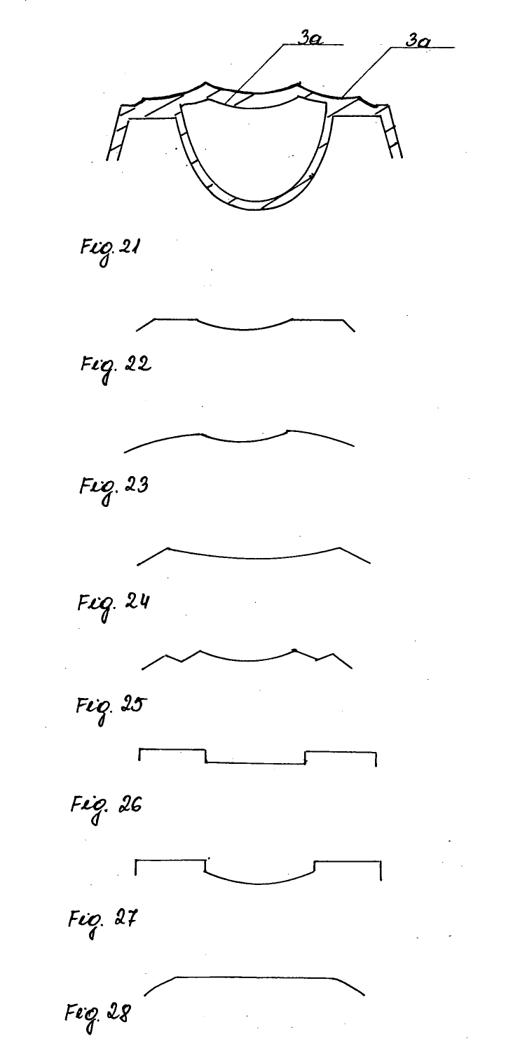

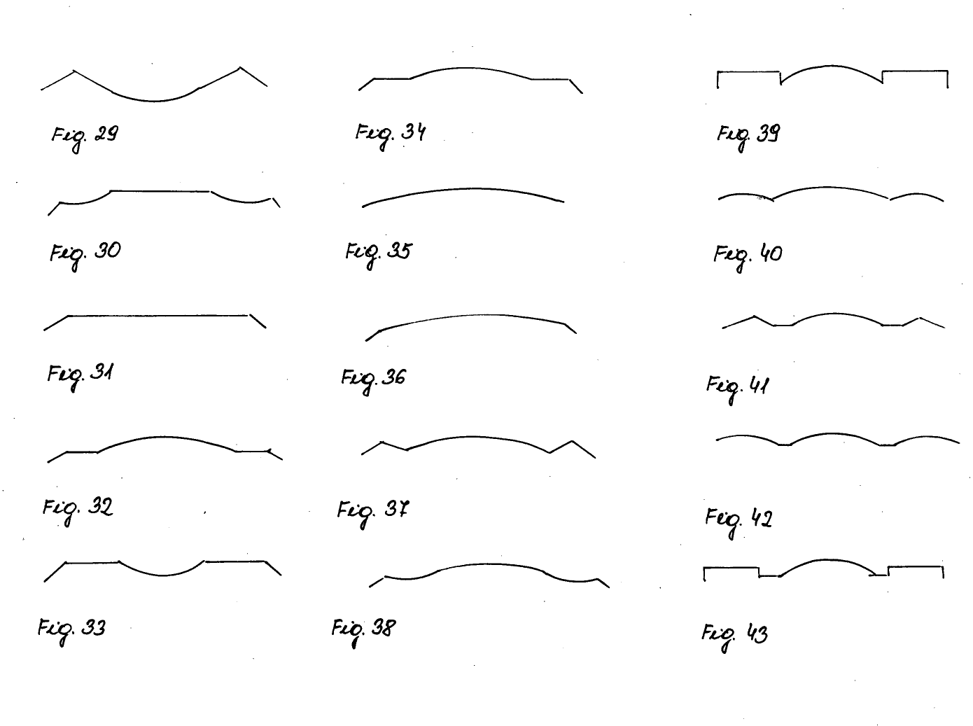

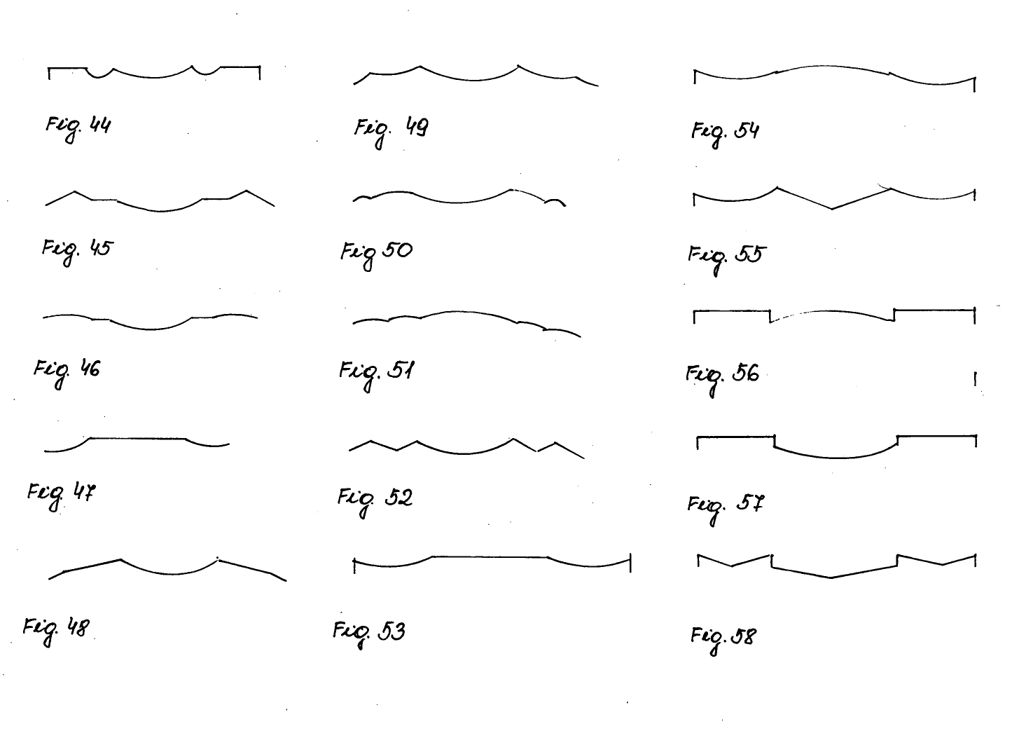

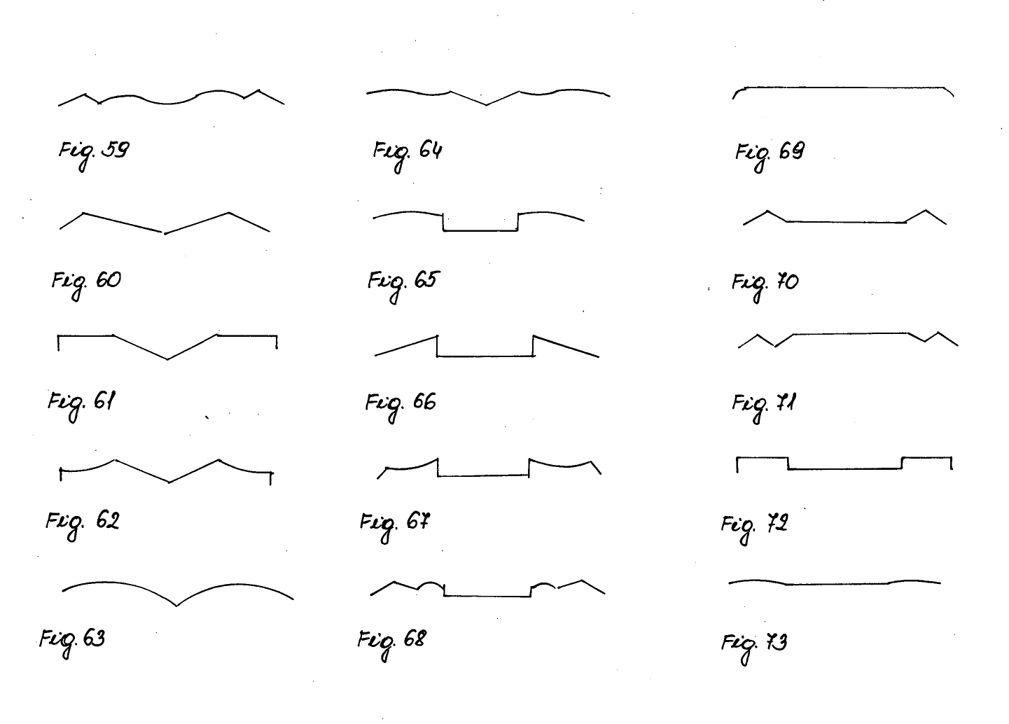

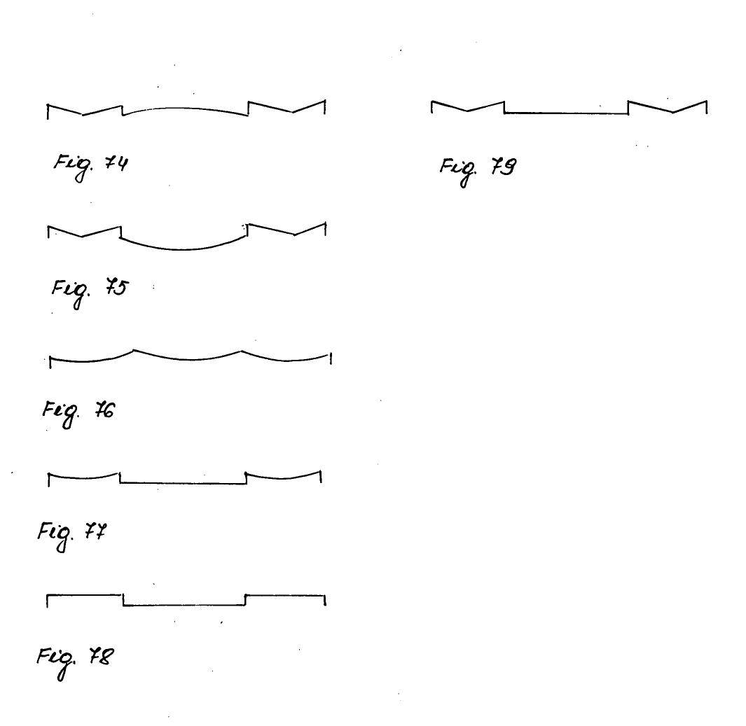

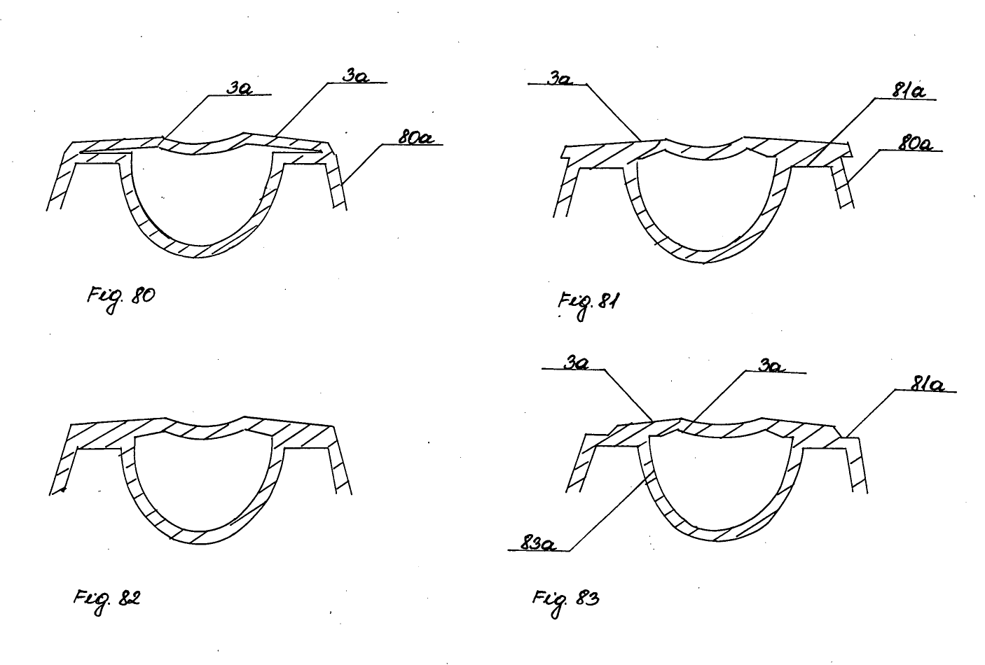

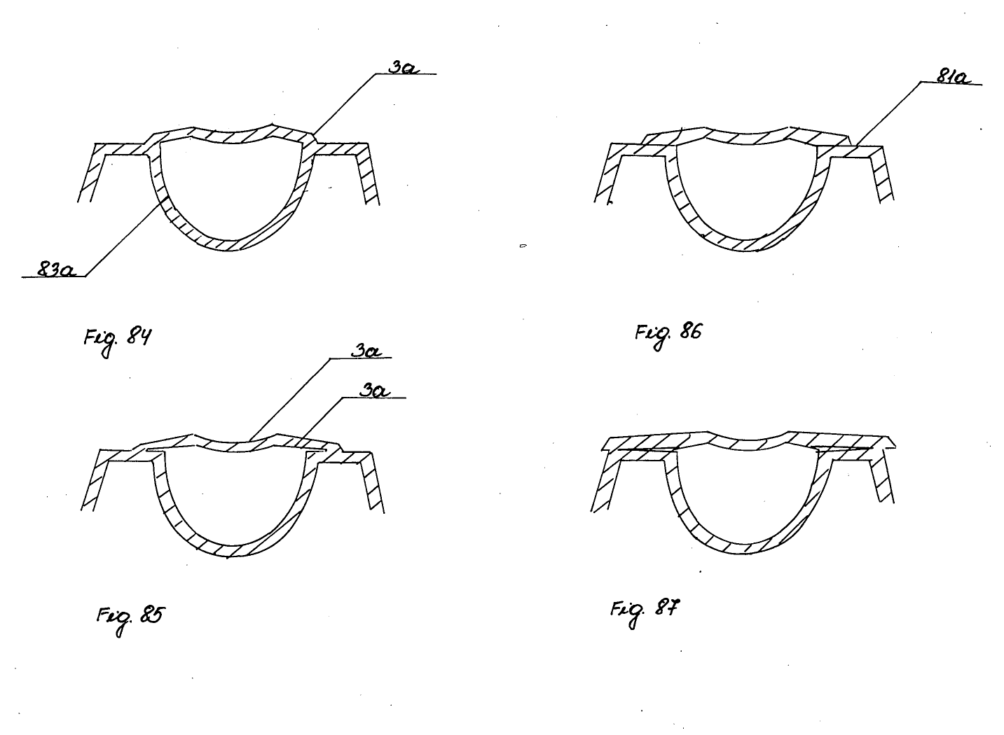

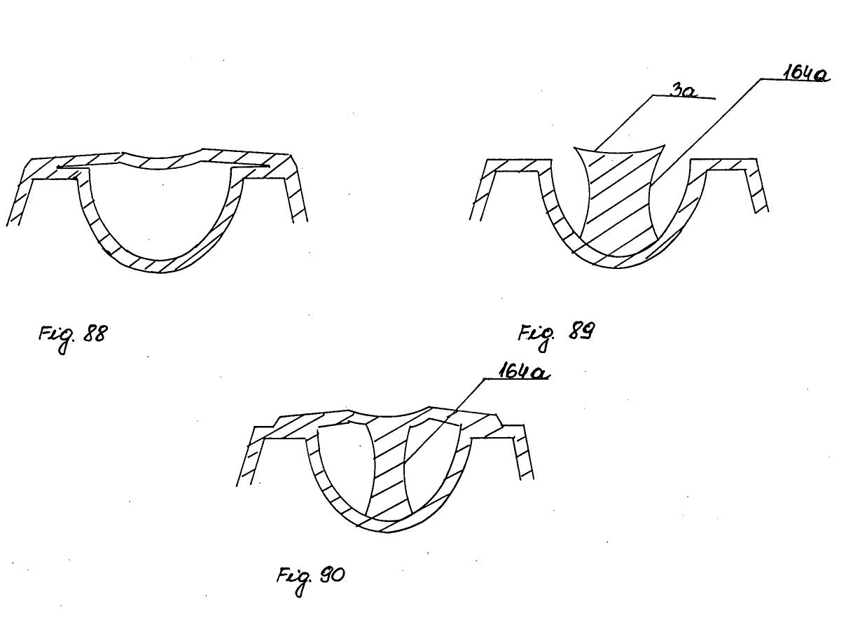

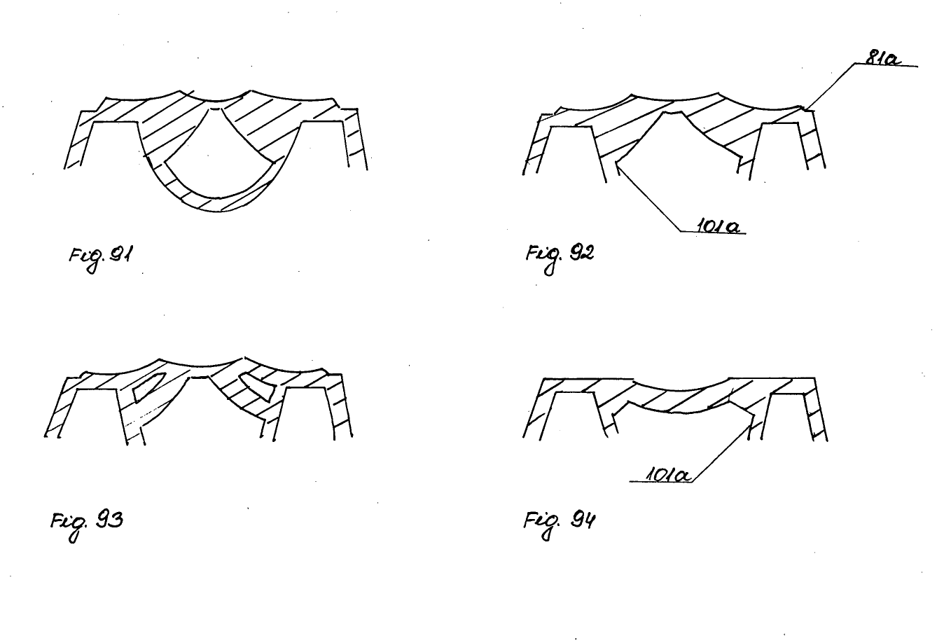

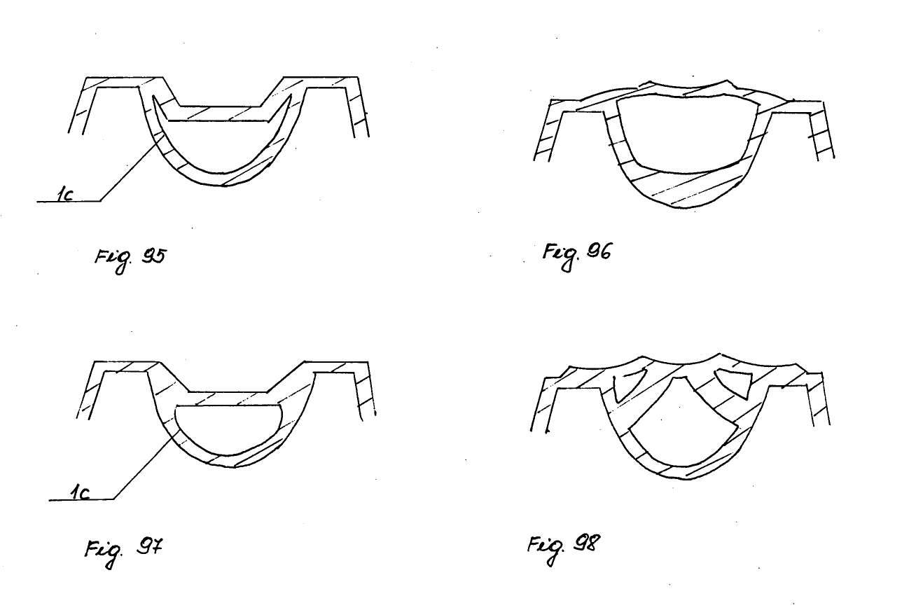

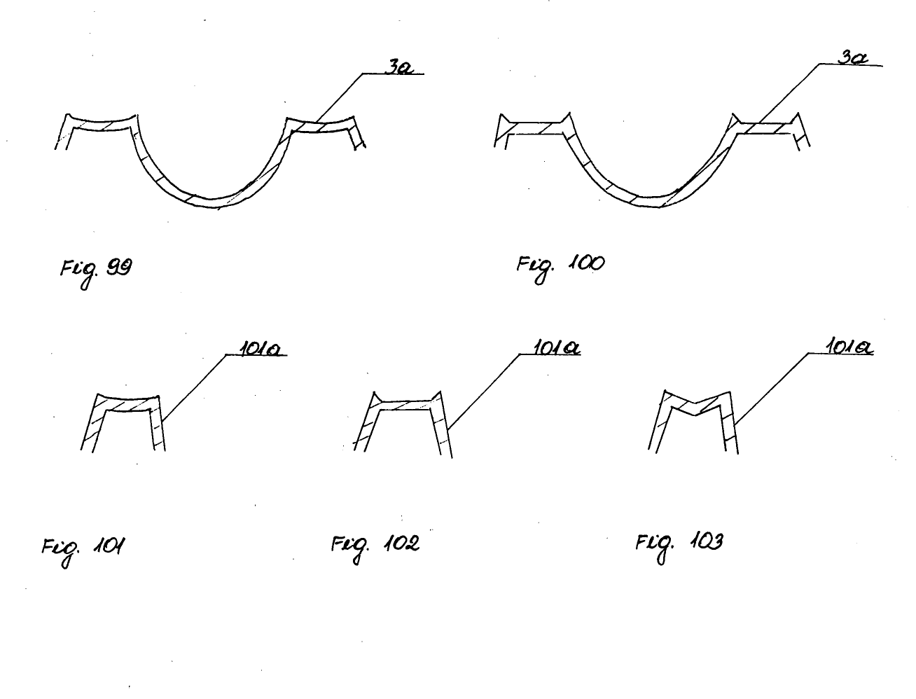

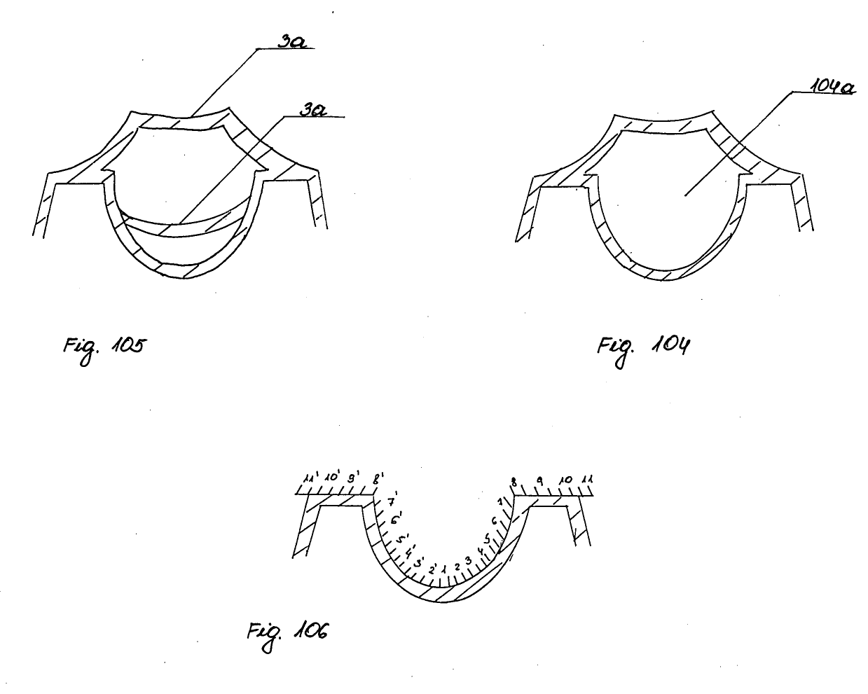

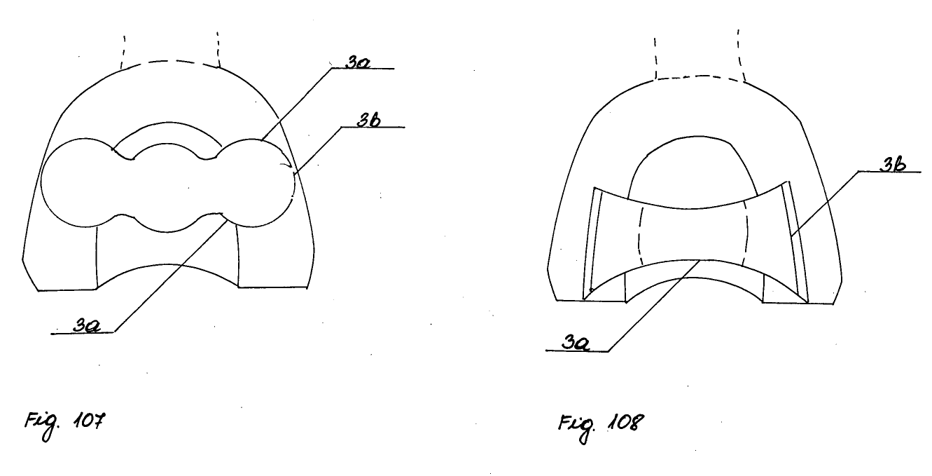

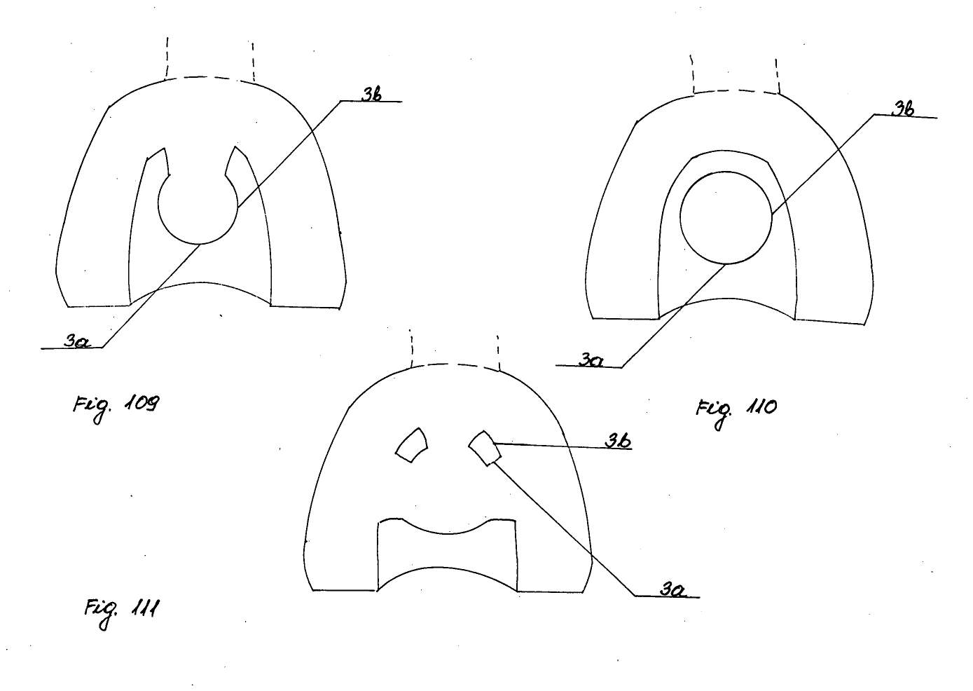

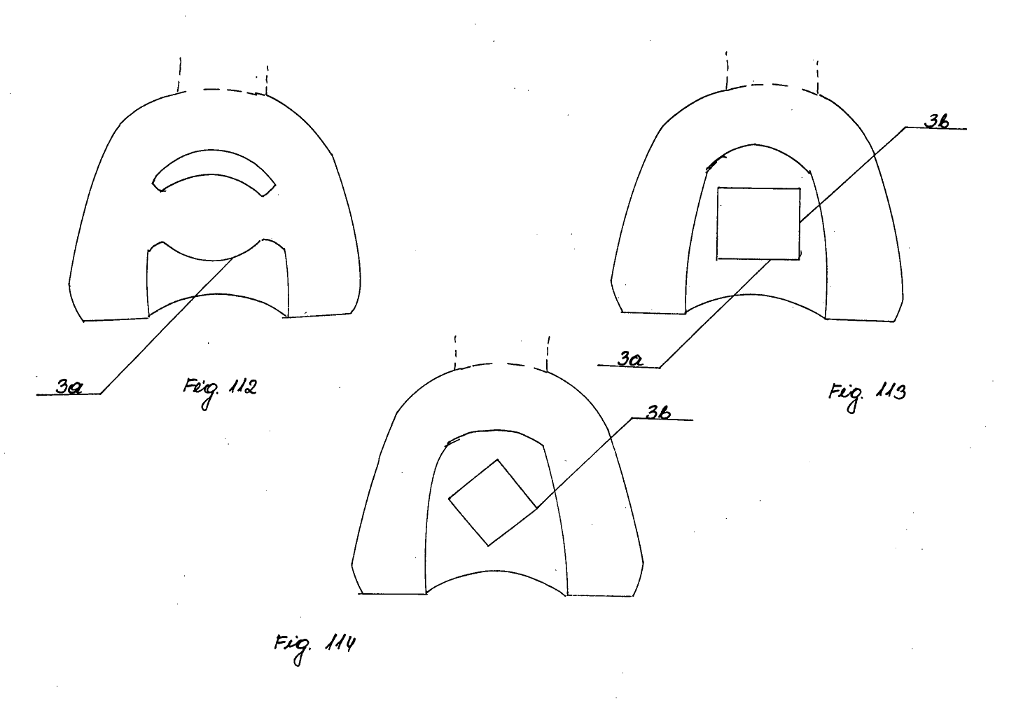

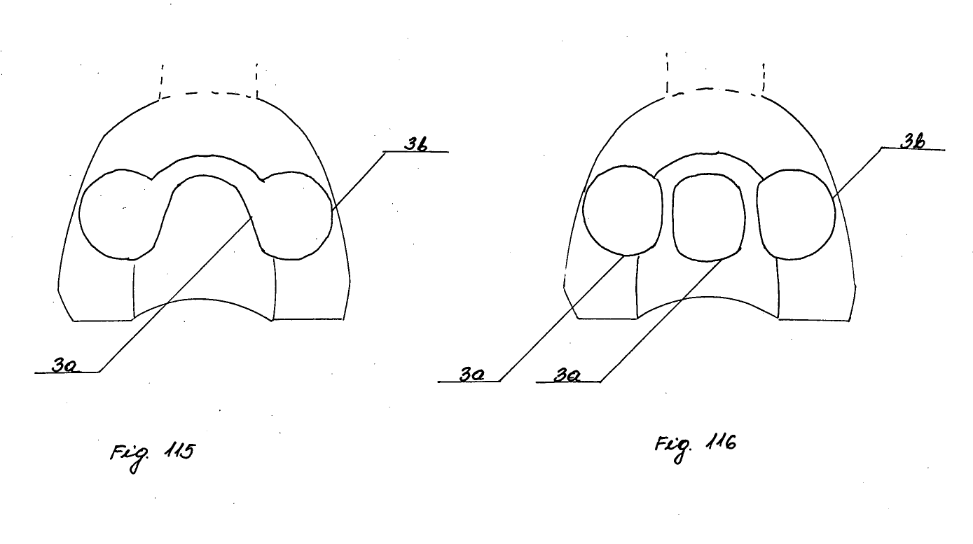

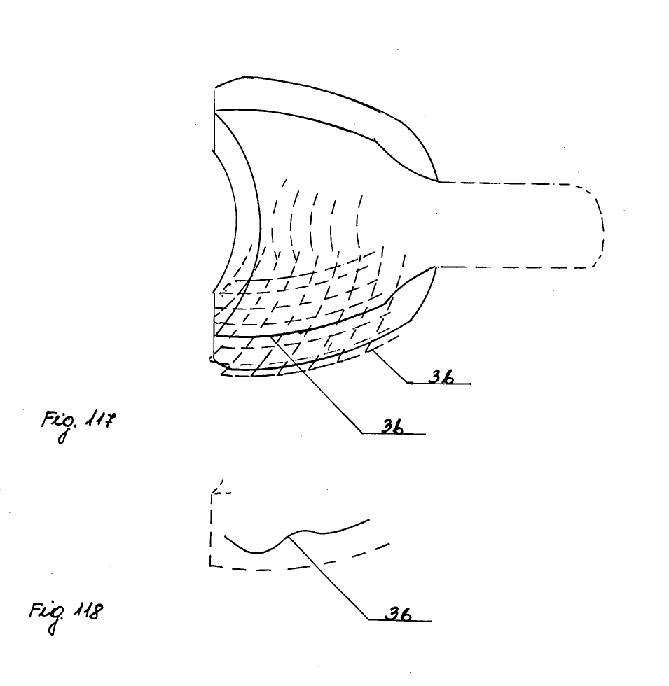

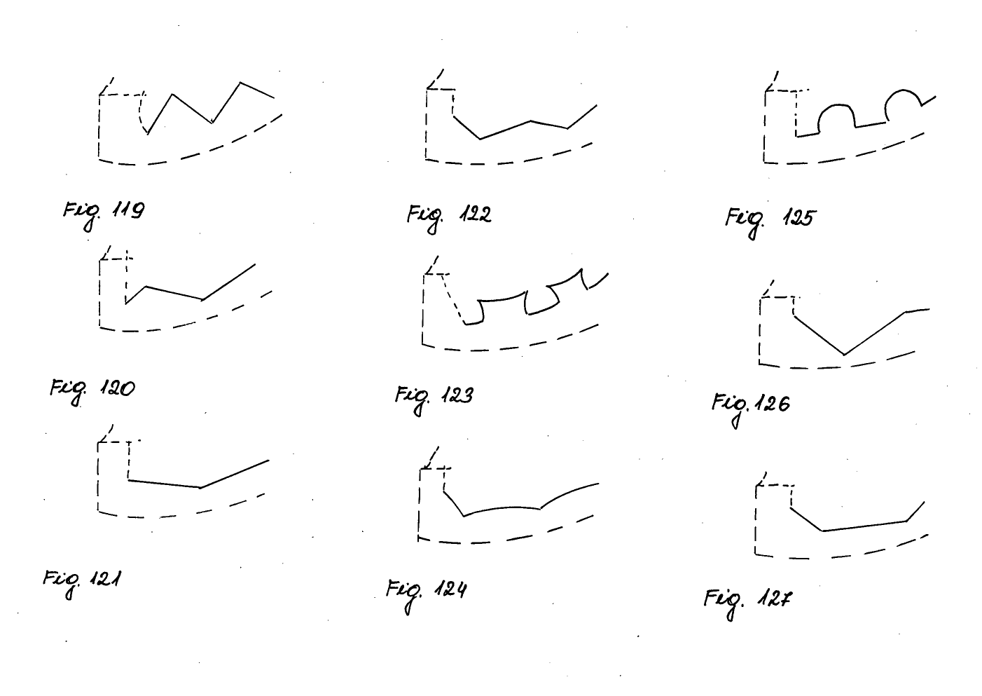

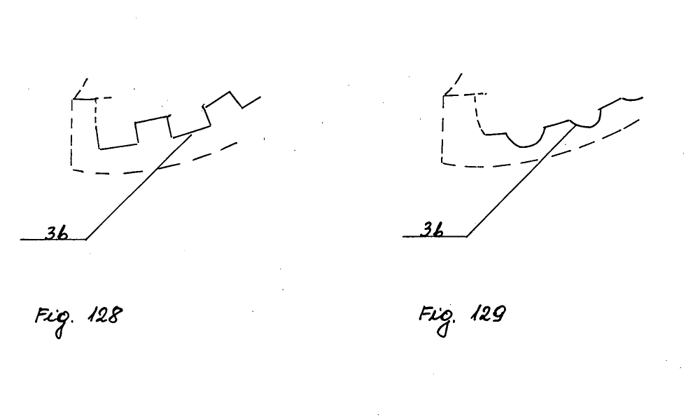

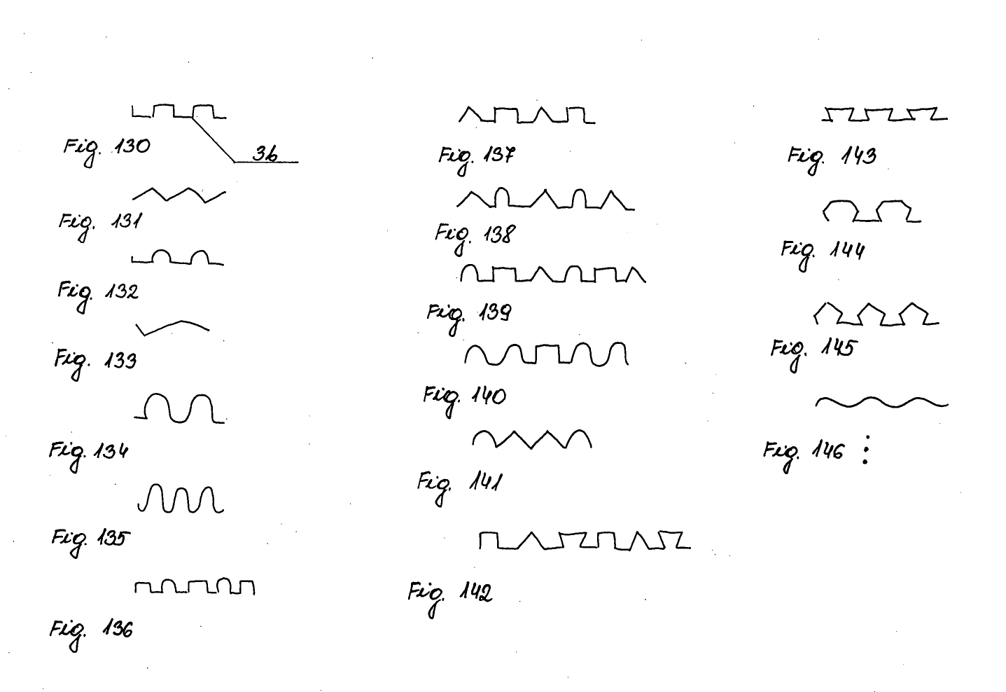

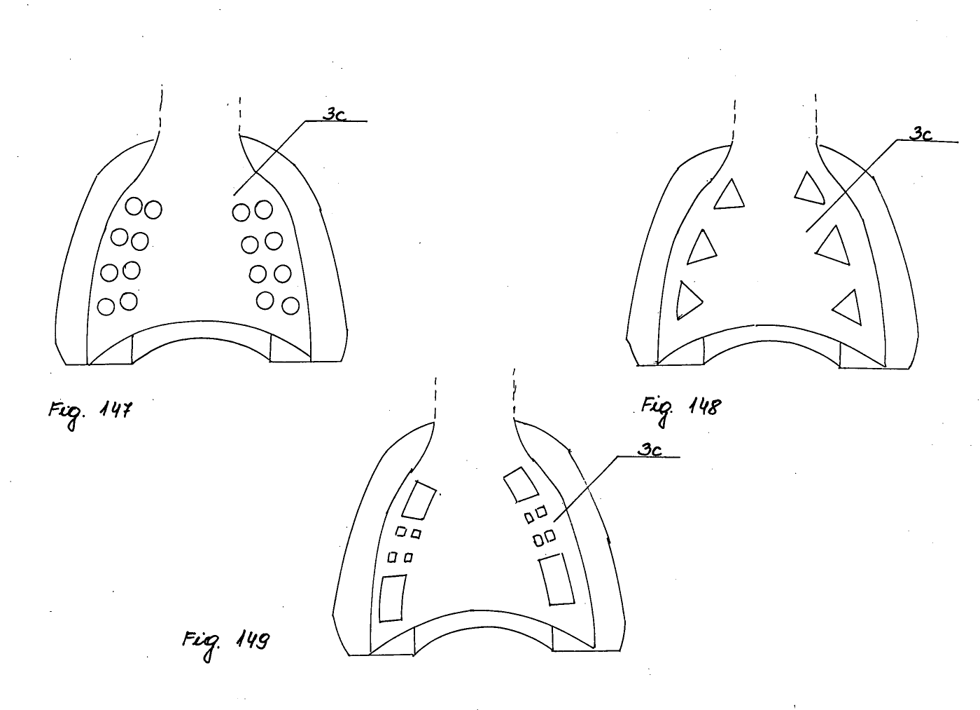

The mould inter-gingival line/lines, top view and the cross-section view, of a dental impression tray, may be a combination of lines of different and/or the same dimensions and/or radiant and/or inclination angle and/or length and/or height and/or thickness. The example lines constitute en element/piece or the whole of the inter-gingival line: circular and/or straight and/or U-shape and/or oval and/or broken line and/or rectangular and/or square and/or oblique and/or triangular, (FIG. 3-18 top view, FIG. 21-79—the cross-section view).

Example combinations of the run of the mould inter-gingival line/lines—the top view. The line shape may be e.g.:—triangular/broken line or square/rectangular or circular or straight,
circular and straight, in any order,
circular and triangular/broken line, in any order,
circular and square/rectangular, in any order,
triangular/broken line and square/rectangular in any order,
triangular/broken line or square/rectangular and straight in any order,
triangular/broken line, square/rectangular, circular and straight in any order.

The gingival line/lines of the mould (FIG. 3 3b position) runs/run alongside the gingival and/or palatal and/or lingual area of a dental impression tray. Alongside means from the front to the back/from the back to the front of a dental impression tray. It/they run from the front backward/from the back frontward of a dental impression tray and it/they may run at an angle to the gingival area of a dental impression tray. It/they may be shorter or longer than the length of the gingival area of a dental impression tray (FIG. 117-146). It/they may be unconnected. It/they may be connected to each other and/or to the palatal and/or gingival and/or lingual area of a dental impression tray, at any point of a dental impression tray, running from the front backward/from the back frontward of a dental impression tray. The front of a dental impression tray is located at the grip point of a standard dental impression tray. The gingival line/lines that may form a connection of a mould with a standard or other dental impression tray—the side view and the top view—may be a combination of the example lines (FIG. 117-146) of different and/or the same dimensions and/or radiant and/or inclination angle and/or length and/or height and/or thickness. The example lines constitute an element or the whole of the gingival line: circular and/or straight and/or U-shape and/or oval and/or broken line and/or rectangular and/or square and/or oblique and/or triangular. (FIG. 117-146).

Example combinations of the run of the mould gingival line/lines—the top view. line shape may be e.g.:—triangular/broken line or square/rectangular or circular or straight,
circular and straight, in any order,
circular and triangular/broken line, in any order,
circular and square/rectangular, in any order,
triangular/broken line and square/rectangular in any order,
triangular/broken line or square/rectangular and straight in any order,
triangular/broken line, square/rectangular, circular and straight in any order.

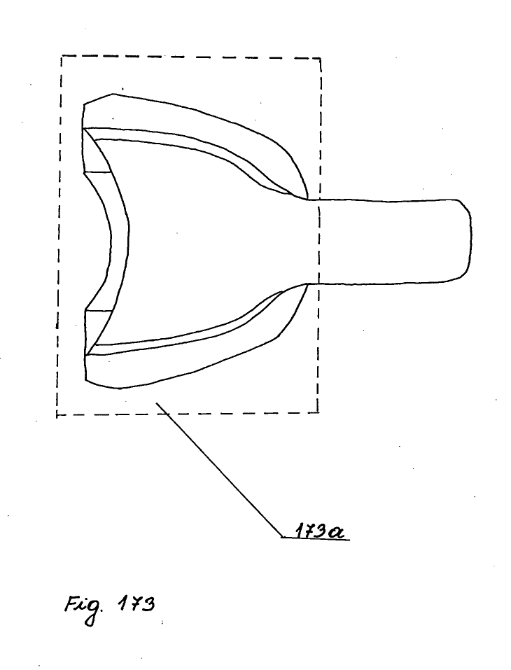

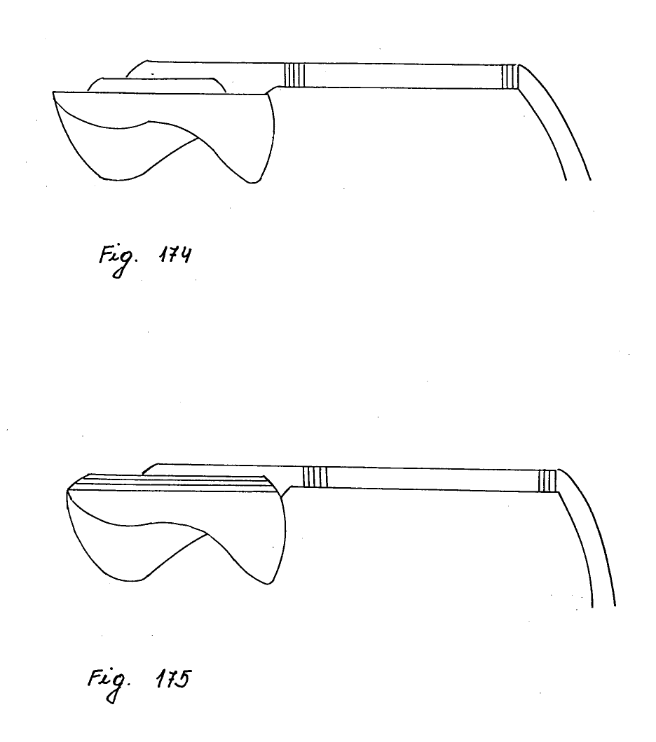

The gingival line of the mould, constituting a joint of the mould with a dental impression tray—the top view—may have any shape, length, size, layout, perforation, notches, patterns, singular or in any combination (FIG. 151,152). The palatal/lingual line/lines of the mould (FIG. 164, 164a position)/the palatal/lingual line of the mould—e.g. the cross-section view, runs/run from the top downwards/from the bottom upwards of a dental impression tray. Usually it/they is/are connected to the palatal member (FIG. 1, 1c position), (FIG. 164-172) and/or lingual member (FIG. 101, 101a position) in the lower impression tray. It/they may be unconnected. It/they may be connected to the palatal area and/or lingual and/or gingival area at any point of a dental impression tray, running from the top downward/from the bottom upward of a dental impression tray. The palatal/lingual line and/or lines run from the top downward/from the bottom upward of a dental impression tray and may run at an angle to the gingival area of a dental impression tray. the top of a dental impression tray—the cross-section view—is located at the highest point of a dental impression tray. The bottom of a dental impression tray is located at its lowest point, the cross-section view. The palatal/lingual line/lines of the mould (FIG. 164, 164a position) may be a combination of the example lines (FIG. 164-172, 89-94, 98) of different and/or the same dimensions and/or radius and/or inclination angle and/or length and/or height and/or thickness. The example lines constitute an element or the whole of the palatal/lingual line—circular and/or straight and/or U-shape and/or oval and/or broken line and/or rectangular and/or square and/or oblique and/or triangular (FIG. 164-172).

Example combinations of the run of the mould palatal/lingual line/lines, the cross-section view (FIG. 164-172, 89-94, 98):—triangular/broken line or square/rectangular or circular or straight,
circular and straight,
circular and triangular/broken line, in any order,
circular and square/rectangular, in any order,
triangular/broken line and square/rectangular in any order,
triangular/broken line or square/rectangular and straight in any order,
triangular/broken line, square/rectangular, circular and straight in any order.

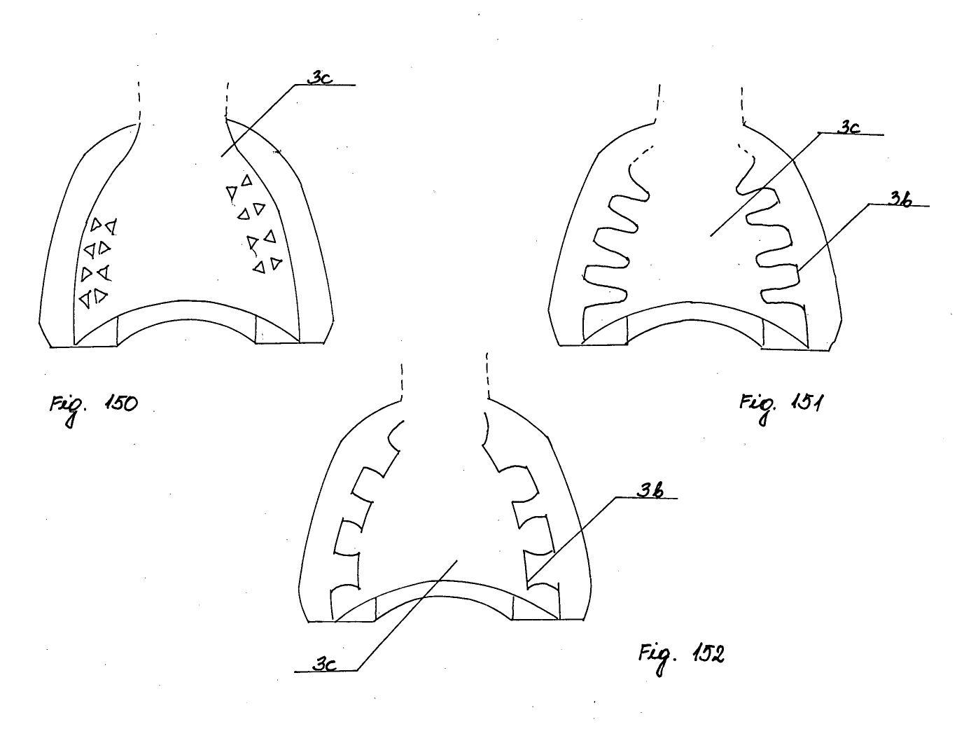

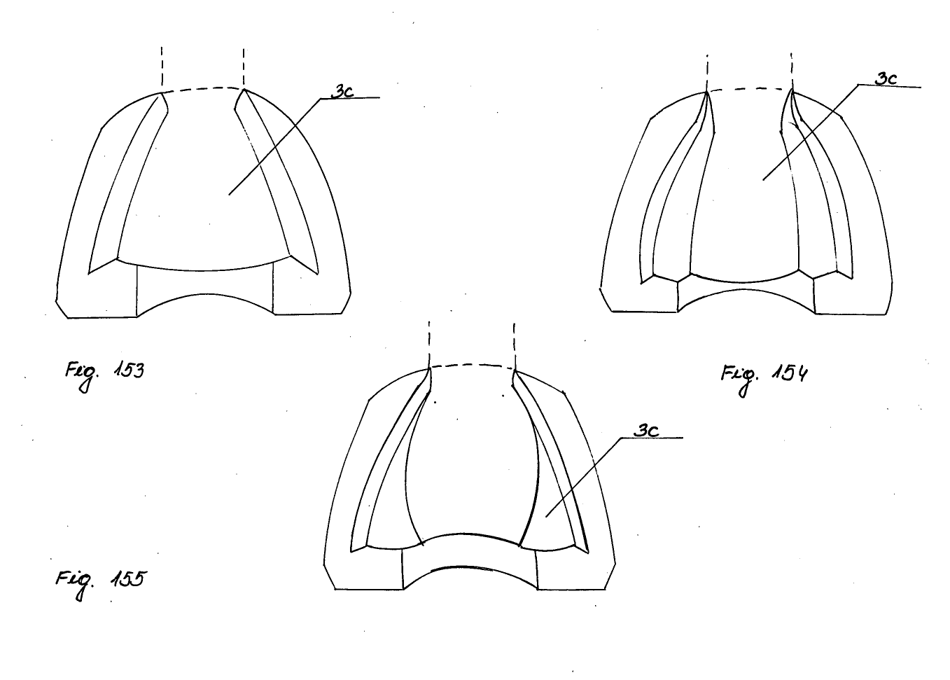

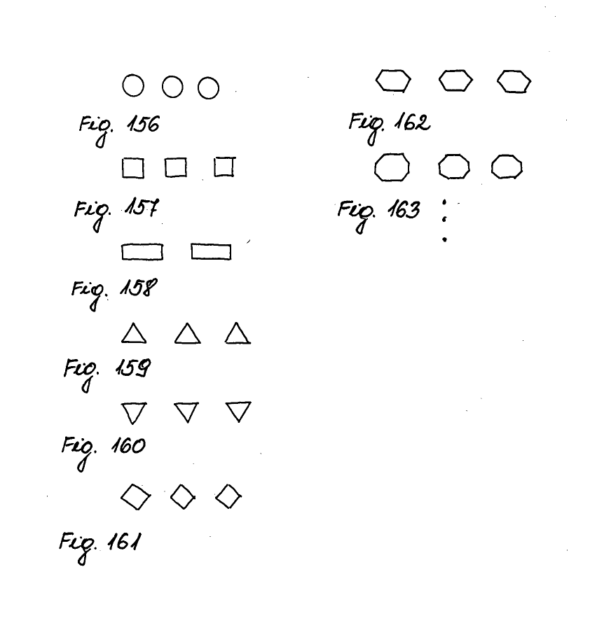

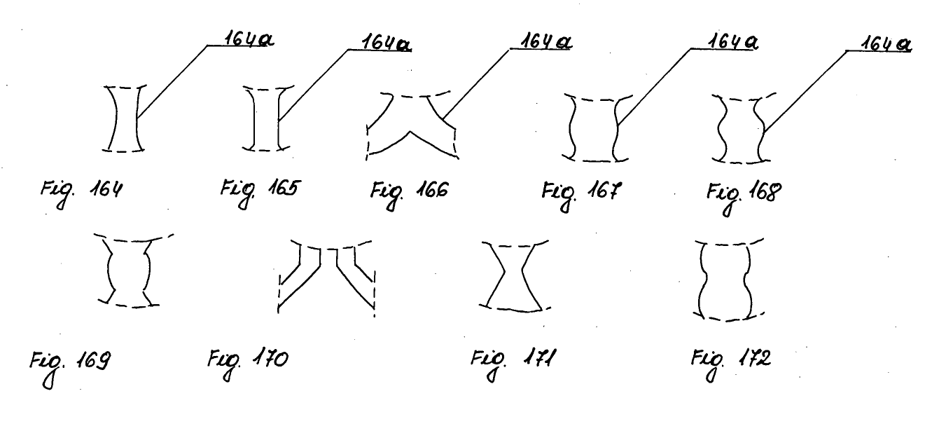

The mould surface and/or the dental impression tray, the top view, may have any shape, length, size, layout, perforation, embossing, patterns, singular or in any combination (FIG. 147-163).

The mould surface—the top view—does not need to be straight; it may be crooked at any angle and/or may be convex and/or concave with any radiant, of any shape in each fragment of a dental impression tray (FIG. 153-155).

A dental impression tray, its mould and structure, e.g. hydraulic or pressure structure, may have any shape, provided it fulfils its function. In the cross-section view and/or side view, the mould may be a grip member of any shape, curvature, size, radiant, or structure . . . (FIG. 104, 105, 108), provided it enables inserting a dental impression tray into a patient's mouth.

The connection of the mould to a standard or other type of dental impression tray may be located at any point of the gingival and/or palatal and/or lingual area, it may be of any length and width. In the top view and/or side view, it may coincide with the gingival line/lines of the mould (FIG. 1, 1a position). The cross-section view, it may coincide with the inter-gingival line/lines and/or with the palatal/lingual line/lines, and/or with its/their fragment/fragments. The connection of the mould to a standard or other type of dental impression tray—the cross-section view—may follow such combinations as:—in item 1 or 2 or 3 or 4 or 5 . . . —in item from 2 to 2′, from 3 to 3′, from 4 to 4′ . . . —in item from 2 to 2′ and in item 8 and 8′, from 3 to 3′ and in item 9 and 9′ . . . —in item from 2 to 2′ and in item 8 to 9 and 8′ to 9′ . . . —in item 2 and 2′, 3 and 3′, 4 and 4′ . . . —in item 2 and 2′ and 8 and 8′, 3 and 3′ and 9 and 9′ . . . —in item from 2 to 5 and 2′ to 5′, from 8 to 10 and from 8′ to 10′ . . . —in item from 11 to 11′ . . . (FIG. 106, 91-98).

1. The steady pressure dental impression tray comprises the part used for reproduction of the prosthetic area in a patient's mouth, the grip member protruding outside this part, and the mould or structure, e.g. pressure mechanism.
The steady pressure dental impression tray is a dental impression tray where the impression force is preferably applied through/by means of a mould and/or a structure to the part used for reproduction of the prosthetic area in a patient's mouth. The steady pressure dental impression tray provides better or steady application of the pressure force during the impression taking. The steady pressure dental impression tray and/or the mould and/or the structure and/or the grip member may comprise two parts, and may disconnected, however get connected during the impression taking.

2. The mould and/or the structure, according to claim 1, may have a modified shape of a standard dental impression tray or any dental impression, with just slight change to its appearance.

3. An object making its impression in soft material, due to the force application, of various strength and impact directions, reproduces its parts at different heights, thus providing a distorted cast of the object.
